(19) United States
(12) Patent Application Publication
(10) Pub. No.: US 2002/0175233 A1
(43) Pub. Date: Nov. 28, 2002

(54) Mobile tire cruncher and method thereof

(76) Inventor: Matt Friedlander, Moultrie, GA (US)

Correspondence Address: Christopher J. McDonald, Esq., HOFFMAN, WASSON & GITLER, PC, Suite 522, 2361 Jefferson Davis Highway, Arlington, VA, 22202, US

(21) Appl. No.: 09/864,318

(22) Filed: May 25, 2001

(51) Int. Cl. B02C 19/12

(52) U.S. Cl. 241/30; 241/95

(57) ABSTRACT

The mobile tire cruncher utilizes a trailer to support a hydraulic press punch and removable die. The press punch and die cooperate with one another to form small chips from used tires. The die is removable so that any shaped chip may be made by using a die with that shape openings. The trailer has wheels so that the trailer may be transported to the site of the used tires. The press punch is powered by a hydraulic cylinder and the trailer supports a power unit for causing movement of the press punch. Hydraulic stabilizers extend from the trailer to support the tire cruncher during use.

### FIELD OF THE INVENTION

The invention relates to a method and apparatus for reducing used tires into smaller pieces by using a press punch and die for purposes of recycling.

### BACKGROUND OF THE INVENTION

When the tread on a tire wears down, it is no longer suitable for use on an automobile or other vehicle. At this point, drivers replace their tires and the old tires are disposed of by placing them in a landfill. To be placed in a landfill, tires must be cut into pieces so that they do not hold water. Drivers buying new tires pay a fee for the disposal of the old tires. Some tire landfills have millions of tires that have accumulated over decades. Tires do not decompose at an appreciable rate and pose an environmental hazzard. Occasionally, stock piles of old tires catch fire creating toxic fumes and liquid run off.

There are several known uses for old tires. Tires can be recycled in order to reclaim the oil used in the manufacture of other rubber. Ground or shredded rubber is useful for skid resistant highway surfaces and resilient surfaces such as running tracks. Tire pieces are approved, in lieu of gravel, for septic tank drain fields. The chips are lighter and easier to work with. The reduced weight of the tire chips, as compared to gravel, reduces transportation costs. Tire chips are also useful in erosion control and as a mulch in crop and shrubbery growing. Additionally, specially designed furnaces are able to burn rubber pieces to create energy. New and future uses will develop as the supply of tire pieces becomes more prevalent. However, to be utilized for the above-noted uses, the tires must be cut.

The resiliency of tires and their resistance to cutting makes the reduction of tires into smaller pieces difficult. The prior art discloses devices designed to receive old tires and reduce them to smaller pieces. One such device is disclosed in U.S. Pat. No. 4,156,508 to Kisielewski. A tire 22 is placed between two parallel shear rotor assemblies 40 and 42. Each shear rotor assembly includes a plurality of shear blade discs.

U.S. Pat. No. 5,551,325 to Schutt discloses a tire cutting machine. In one embodiment, a sliding block assembly 28 pushes a tire against a cutting die 50 for removing the bead from a tire. An indexing mechanism rotates the tire for successive cutting cycles in order to reduce the tire to pieces. In a second embodiment, a plurality of punches 110 having cutting edges 111 cooperate with a die block assembly 113 to form circular or square pieces from a tire. The plurality of punches necessitates a complex machine.

U.S. Pat. No. 4,374,573 to Rouse et al, discloses an apparatus for shredding rubber tires utilizing feeder-stripper rolls 52 leading to cylindrical cutter rolls 50 for forming small pieces from used tires.

U.S. Pat. No. 5,601,240 to Merklinger et al, discloses a mobile tire shredder having shearing blades 46 with teeth 46a. The shearing blades are housed within the body assembly of a truck.

The prior art does not disclose an apparatus for simultaneously forming a plurality of uniform sized pieces from a tire.

It is therefor an object of the invention to provide a device that reduces used tires to chips of uniform size.

It is another object of the invention to provide a tire cruncher that is mobile so that it may be taken to locations having a large amount of used tires.

It is another object of the invention to provide a mobile tire cruncher that is efficient in its use to reduce tires to chips.

It is another object of the invention to provide a tire cruncher that can produce tire chips of any desired size and shape.

These and other objects of the invention will become clear to one of ordinary skill in the art after reviewing the description of the invention.

### SUMMARY OF THE INVENTION

A mobile tire cruncher according to the present invention utilizes a trailer to support a hydraulic press punch and removable die. The trailer has wheels so that the trailer may be transported to the site of the used tires. The press punch and die cooperate with one another to form small chips from used tires. The die is removable so that any shaped chip may be formed by replacing that die with a second die. The press punch is powered by a hydraulic cylinder and the trailer supports a power unit for causing movement of the press punch. Hydraulic stabilizers extend from the trailer to support the tire cruncher during use.

Before a tire is reduced into pieces, the bead is removed. The removal of the bead reduces the amount of pressure necessary to operate the punch. The bead can be removed in a separate procedure, using a manual or automatic tool or a bead removing implement can be incorporated into the apparatus of the invention.

The resulting device is a smaller, mobile machine which is less expensive and easily used. The reduced cost allows small dealers to purchase or rent the machine and is ideal for small communities and dealers in remote, or rural areas. With the smaller, inexpensive and mobile machine, it is not necessary to have very large number of tires in order for the use of the machine to become economically feasible. Even a small number of tires can be economically disposed of with the machine.

### BRIEF DESCRIPTION OF THE DRAWINGS

The invention will be described with reference to the following drawings:

FIG. 1 is a side view of the device;

FIG. 2 is a top view of the device;

FIG. 3 is an end view of the device;

FIG. 4A is a top view of one type of die;

FIG. 4B is a side cross-sectional view of the die of FIG. 4A;

FIG. 5A is a top view of a punch used with the die shown in FIG. 4A;

FIG. 5B is a side cross-sectional view of the punch shown in FIG. 5A;

FIG. 6A is a top view of an alternative embodiment of a die;

FIG. 6B is a side cross-sectional view of the alternative die shown in FIG. 6A;

FIG. 7A is a top view of an alternative embodiment of a punch used with the die shown in FIG. 6A; and

FIG. 7B is a side cross-sectional view of the alternative embodiment of the punch shown in FIG. 7A.

### DETAILED DESCRIPTION OF THE DRAWINGS

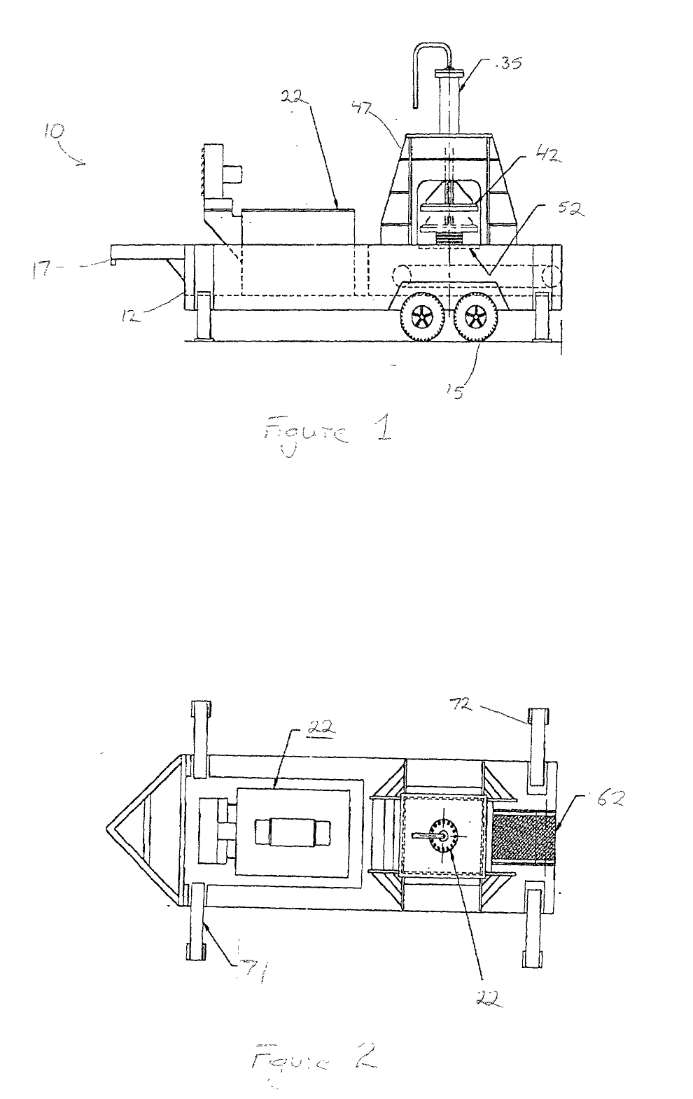

Referring to FIG. 1, the side view of the tire cruncher 10 is illustrated. The tire cruncher consists of a trailer 12 supporting the various parts of the device and having a pair of axles supporting wheels 15 allowing the cruncher to move from site to site. At the front of the tire cruncher, a hitch 17 enables the tire cruncher to be attached to and towed by a vehicle.

Close to the front of the cruncher is a power unit 22 for supplying power to a hydraulic cylinder 35. The power unit may be any conventional device able to provide the necessary energy for the operation of the hydraulic cylinder 35 in a reciprocating motion. The hydraulic cylinder is attached to and operates a press punch 42. The hydraulic cylinder and press punch tandem is supported by tower 47. The tower provides a framework for supporting the hydraulic cylinder and press punch in its reciprocating motion. The press punch cooperates with a removable die 52 in the tire crunching process.

The top view of the device is illustrated in FIG. 2.

The relative positions of the power unit and hydraulic cylinder is seen, as is a conveyor 62. The conveyor extends from underneath the removable die 52 to the rear edge of the trailer.

When the press punch is lowered onto the removable die, a tire placed on the die is broken into small pieces which fall through the die and onto the conveyor. The conveyor transports the pieces falling from the die to the rear edge of the conveyor where they are handled in any manner that the operator wishes. Typically, the tire chips will be collected into one or more receptacles for later processing to their final use.

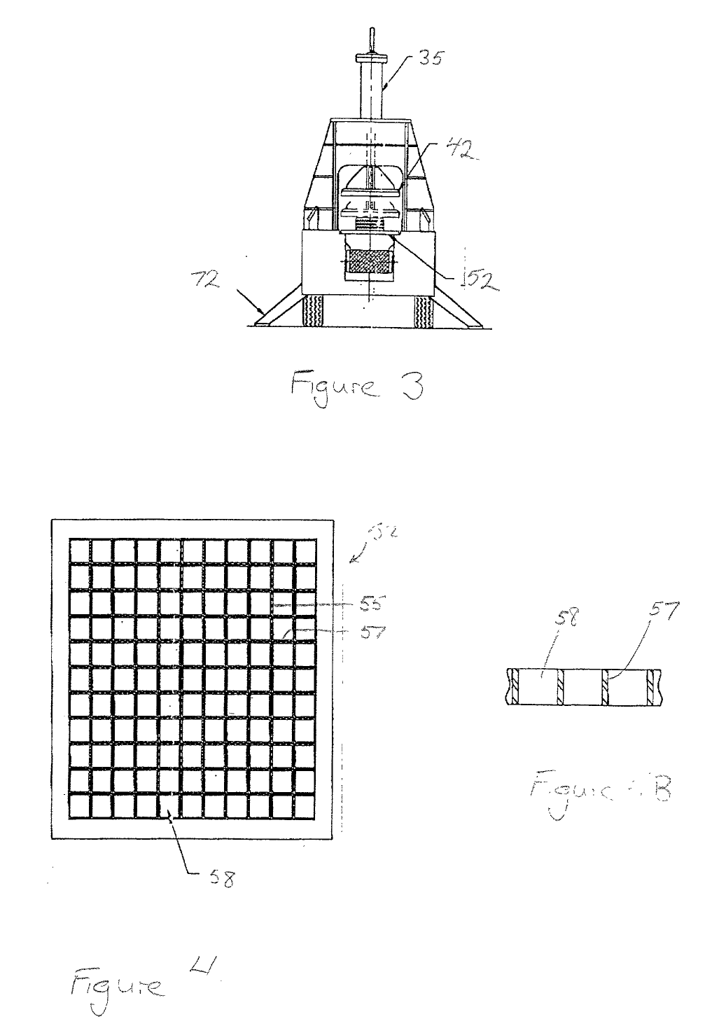

The end view of the tire cruncher, seen in FIG. 3, clearly shows the use of the hydraulic stabilizers. The front end of the device is supported by front hydraulic stabilizers 71 when the trailer hitch is not connected to another vehicle. A set of rear hydraulic stabilizers 72 also extends from the trailer to the ground to stabilize the tire cruncher during use.

FIG. 4A shows a top view of one type of removable die 52. The removable die has a grid 54 formed by longitudinal walls 55 and transverse walls 57. Together, the walls form holes 58 having a typical dimension of 2 inches square. The side cross-sectional view shown in FIG. 4B shows the longitudinal walls 57 and the space between them forming the holes 58.

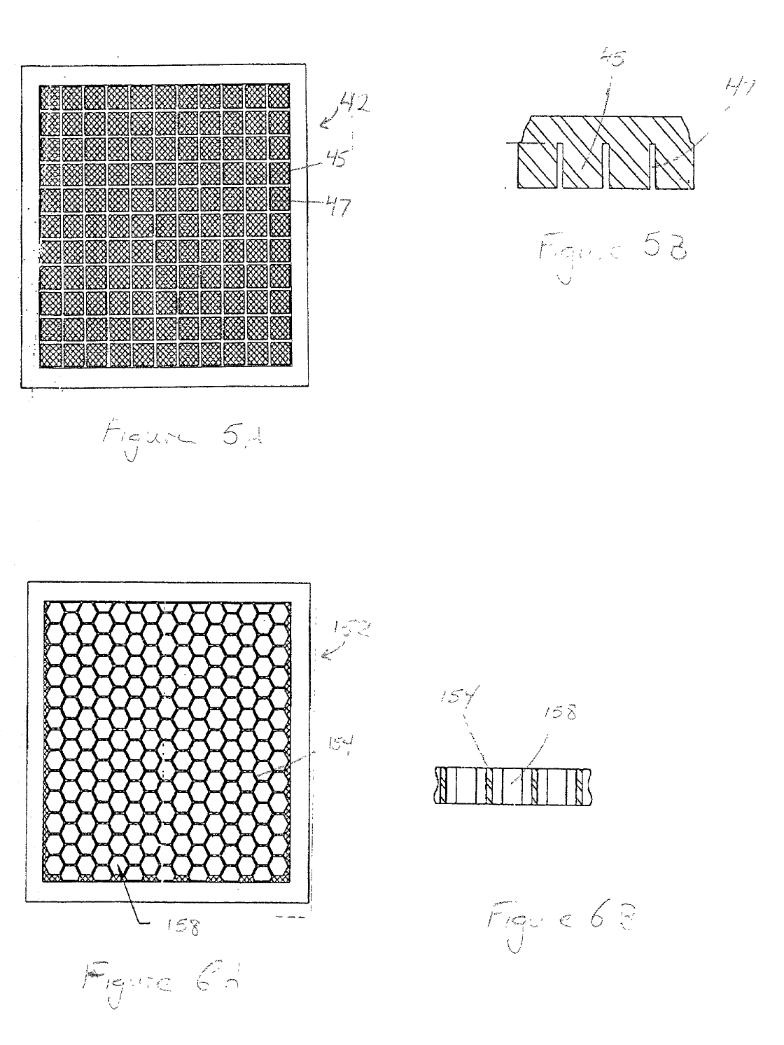

The top edge of the longitudinal walls 53 and transverse walls 57 may be sharpened to facilitate the cutting of the tire as it is forced through the die by the punch. For this reason, the longitudinal walls and transverse walls can be interlocked. In this manner, the walls may be separately removed and the top edges sharpened by any conventional method. The top view of the press punch used in conjunction with the die shown in FIGS. 4A and 4B is seen in FIG. 5A as it consists of projections 45 formed by slots 47. The cross-sectional view is seen in FIG. 5B showing slots 47 having a greater dimension than the walls of the removable die. In this manner, the press punch can be pushed through until the projections 45 have traveled through the holes 58 constructed from the longitudinal walls 55 and transverse walls 57. It is noted that the projections 45 do not make contact with the press plate during this process.

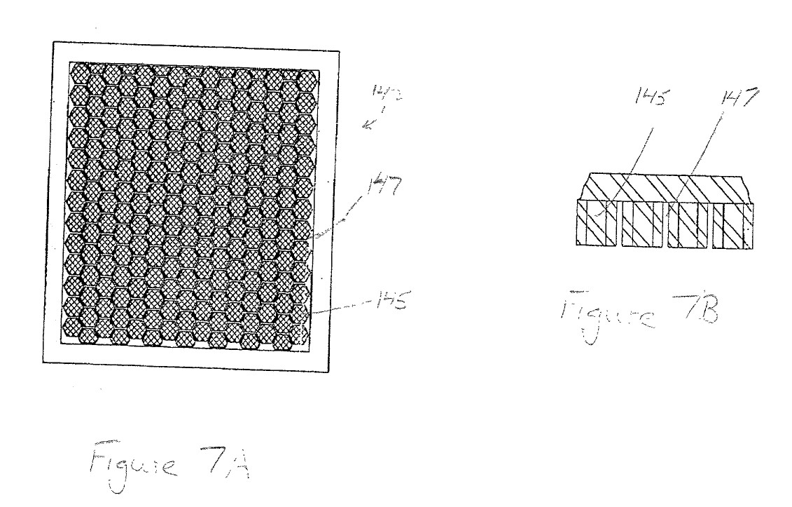

An alternative embodiment of the removable die is illustrated in FIG. 6A. This removable die 154 has a series of walls forming hexagonal shaped holes 158. A cross-sectional view is seen in FIG. 6B and clearly illustrates the walls making the hexagonal holes 158. The corresponding press plate 145 for the alternative embodiment of the die is shown in FIG. 7A. This press plate 145 has hexagonal projections 147 that mate with the hexagonal openings 158. The slots 147 formed within the press plate to form the projections have a depth greater than the height of the walls so that there is no interference when the press plate is fully pushed through the removable die.

With the structure of the tire cruncher having been described, the use of the tire cruncher will now be described. After the tire cruncher is brought to the location where the tires will be processed, the hydraulic stabilizers 71 and 72 are lowered to make contact with the ground. Once this is accomplished, the tire cruncher is stabilized and ready to be used. The power unit is activated to operate the hydraulic cylinder. A tire is placed on a removable die and the hydraulic cylinder is pressurized to lower the press punch toward the removable die. The press punch makes contact with the tire and continues downwardly to press the tire thorough the die. In this manner, the tire is reduced to pieces that fit through the openings 58.

The press punch continues downwardly until the bottom surface of the press punch is past the top edge of the die. Since the slots within the press punch are longer than the height of the grid of the press punch, no interference between the die and the press plate occurs. The press punch pushes the tire completely through the removable die and the chips fall onto the conveyor. The device produces a plurality of chips from a tire with a single motion of the press punch.

The conveyor transports pieces from underneath the removable die toward the rear edge of the trailer 12. Typically, a receptacle will be placed at the edge of the conveyor so that tire pieces on the conveyor fall into the receptacle. At this point, a receptacle full of tire chips can be transported to their final processing. As mentioned previously, the final processing can be their use in burning in an appropriate furnace, processed to reclaim the oil in the rubber or used for such purposes as roadway resurfacing, erosion prevention and septic drain fields.

While a preferred embodiment of the invention has been described, the description is not meant to be limiting. Modifications and variations would be obvious to one of ordinary skill in the art upon reading the disclosure of the invention and the invention is intended to accomplish such variations.

What is claimed is:

1. A method for disposing of tires, comprising:
placing a tire on a die;
activating a single press punch; and
moving said press punch toward said die until said press punch pushes said tire through a plurality of apertures in said die to form tire chips.

2. The method of claim 1, wherein said tire chips are carried by a conveyor underneath said die.

3. The method of claim 1, wherein said press punch is activated by a hydraulic cylinder.

4. A method of making tire chips comprising:
placing a tire on a die;
activating a single press punch; and
moving said press punch toward said die until said press punch pushes said tire through a plurality of apertures in said die to form tire chips.

5. The method of making tire chips of claim 4, wherein said tire chips are carried by a conveyor.

6. The method of making tire chips of claim 4, wherein said press punch is activated by a hydraulic cylinder.

7. A tire disposer, comprising:
a die for supporting a tire, said die having a plurality of apertures;
a single press punch cooperating with said die; and
a power unit for actuating said press punch.

8. The tire disposer of claim 7, wherein said die is removable.

9. The tire disposer of claim 7, further comprising a conveyor for transporting the chips from said die.

10. The tire disposer of claim 7, further comprising a trailer supporting said power unit, said press punch and said die, said trailer having wheels.

11. The tire disposer of claim 7, wherein said die has square apertures.

12. The tire disposer of claim 7, wherein said die has hexagonal apertures.
